(19) United States
(12) Patent Application Publication
(10) Pub. No.: US 2026/0089380 A1
(43) Pub. Date: Mar. 26, 2026

(54) COMPACT CAMERA SYSTEM WITH INTEGRATED LIGHT SOURCE

(71) Applicant: Apple Inc., Cupertino, CA (US)

(72) Inventors: Julien Vittu, Saratoga, CA (US); Guy Lederman, Ramat Gan (IL); Katya Gotlib, Petah Tikva (IL); Yaron Gross, Netanya (IL); Rafi Ambar, Ramat Gan (IL)

(21) Appl. No.: 19/298,054

(22) Filed: Aug. 12, 2025

Related U.S. Application Data
(60) Provisional application No. 63/699,479, filed on Sep. 26, 2024.

(51) Int. Cl. H04N 23/56; H04N 23/54; H04N 23/55

(52) U.S. Cl. CPC H04N 23/56; H04N 23/54; H04N 23/55

(57) ABSTRACT

Camera systems having integrated light sources are described. The camera system may include a printed circuit board, a camera module, a bracket, a first light source, and a set of electrical interconnects. The printed circuit board has a flexible portion and a rigid portion. The camera module is mounted to the rigid portion of the printed circuit board and includes a lens barrel. The first light source is mounted to a top surface of the bracket. The set of electrical interconnects are between the rigid portion of the printed circuit board and the bracket. The bracket at least partially surrounds the lens barrel. The bracket is mounted to at least the rigid portion of the printed circuit board. The first light source is electrically connected to the printed circuit board via the set of electrical interconnects.

### CROSS REFERENCE TO RELATED APPLICATION

This application is a nonprovisional of, and claims the benefit under 35 U.S.C. § 119(e) of U.S. Provisional Patent Application No. 63/699,479, filed on Sep. 26, 2024, the contents of which are incorporated herein by reference as if fully disclosed herein.

### TECHNICAL FIELD

The described embodiments relate generally to camera systems and, more particularly, to compact camera systems with an integrated light source.

### BACKGROUND

Modern consumer electronic devices take many shapes and forms and have numerous uses and functions. Cameras continue to be an important feature of consumer electronics devices such as smartphones, tablets, and computers. The imaging capabilities of these consumer electronics devices have steadily increased as individual cameras have improved in quality and devices have started integrating multiple-camera (“multi-camera”) systems and depth sensors, allowing users to capture high quality images in an ever-increasing range of situations. In low light conditions, a light source module (also known as a “flash”) may be used to illuminate a scene to facilitate image capture. For a relatively small camera, it may be desirable to reduce a form factor of a camera design to the extent possible. As such, it may be desirable to have a light source module that provide light in a controlled manner to enhance visibility and image quality, while also minimizing the impact to the size of the camera system to the extent possible. Thus, it may be desirable to provide a camera system with an integrated light source module.

### SUMMARY

Described herein are camera systems having integrated light sources.

Some aspects of this disclosure are directed to a camera system that includes a printed circuit board, a camera module, a bracket, a first light source, and a set of electrical interconnects. The printed circuit board has a flexible portion and a rigid portion. The camera module is mounted to the rigid portion of the printed circuit board and includes a lens barrel. The first light source is mounted to a top surface of the bracket. The set of electrical interconnects are between the rigid portion of the printed circuit board and the bracket. The bracket at least partially surrounds the lens barrel. The bracket is mounted to at least the rigid portion of the printed circuit board. The first light source is electrically connected to the printed circuit board via the set of electrical interconnects.

Some aspects of this disclosure are directed to a camera system that includes a printed circuit board, a camera module, a bracket, a first light source, and a set of electrical interconnects. The camera module is mounted to the printed circuit board and includes a lens barrel. The first light source is mounted to a top surface of the bracket. The set of electrical interconnects is between the printed circuit board and the bracket. The first light source is positioned over a portion of a housing of the camera module. The bracket is mounted to the camera module to align an optical axis of the first light source with an optical axis of the camera module. The first light source is electrically connected to the printed circuit board via the set of electrical interconnects.

Some aspects of this disclosure are directed to a camera system that includes a first printed circuit board, a second printed circuit board, a camera module, light source, and a set of electrical interconnects. The first printed circuit board has a flexible portion and a rigid portion. The second printed circuit board has a first portion and a second portion. The first portion is disposed on a top surface of the camera module, and the second portion is mounted to the first printed circuit board. The camera module is mounted to the rigid portion of the first printed circuit board and includes a lens barrel. The first light source is mounted to a top surface of the first portion of the second printed circuit board. The set of electrical interconnects is between the first printed circuit board and the first portion of the second printed circuit board. The first portion of the second printed circuit board at least partially surrounds the lens barrel. The first light source is electrically connected to the first printed circuit board via the set of electrical interconnects.

In addition to the exemplary aspects and embodiments described above, further aspects and embodiments will become apparent by reference to the drawings and by study of the following description.

### BRIEF DESCRIPTION OF THE DRAWINGS

To easily identify the discussion of any particular element or act, the most significant digit or digits in a reference number refer to the figure number in which that element is first introduced.

FIG. 1A shows a rear view of an illustrative example of a device including a light source module as described here. FIG. 1B depicts exemplary components of the device of FIG. 1A.

FIG. 2A shows a perspective view of an example of a camera system including a camera module and a light source, as described here. FIG. 2B depicts a side view of the first example of the camera system of FIG. 2A.

FIG. 3A shows a perspective view of an example of a camera system including a camera module and a light source, as described here. FIG. 3B depicts a side view of the second example of the camera system of FIG. 3A.

FIG. 4A shows a perspective view of an example of a camera system including a camera module and two light sources, as described here. FIG. 4B depicts a side view of the example of the camera system of FIG. 4A.

FIG. 5A shows a perspective view of an example of a camera system including a camera module and a light source, as described here. FIG. 5B depicts a side view of the third example of the camera system of FIG. 5A.

FIG. 6A shows an exploded perspective view of an example of a camera system including a camera module and a set of light sources, as described here. FIG. 6B depicts a perspective view of the example of the camera system of FIG. 6A.

FIG. 7 shows a side view of an example of a portion of a camera system including a camera module and two light sources, as described here.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to compact camera systems with integrated light sources. Consumer electronic devices frequently include a camera module with a light source module. A light source module (also known as a “flash”) of a camera may be used to illuminate a scene to facilitate image capture, for example under low-light conditions. A light source module may include at least one light-emitting diode (LED). For a camera module, a light source module is generally a component separate and distinct from a camera. That is, a camera module is generally a component mounted to a printed circuit board under a transparent (e.g., glass) window, and a light source module is generally a component separately mounted on the same or a different printed circuit board. The light source module may also be under a different transparent housing, or otherwise physically spaced apart from the camera module. Additionally, such devices may have multiple camera modules. As demand for increasingly lighter, thinner, or otherwise smaller consumer electronic devices continue to increase, integration of different components of a camera module, such as camera modules and light sources, may be desired. For example, it may be desirable to integrate a camera module together with one or more light sources under a single transparent window similar in size to the transparent window of a single camera module. However, there are challenges to integrating a light source and a camera module into a single camera system.

In some examples, in such a camera system, light from a light source module may enter a camera module and cause uneven brightness or other distortions in the image if the light source module is placed too close to a camera module. Accordingly, it may be desirable for a light source module to be aligned with a camera module in a particular manner, for example to provide even lighting of a scene by the field of illumination (FOI) of the light source module consistent with the field of view (FOV) of the camera module. For example, misalignment may result in relatively darker and relatively lighter portions of an image captured using a camera system with the camera module pointed at an angle relative to a corresponding light source module. However, achieving such alignment may be challenging for small, integrated camera systems. For example, manufacturing steps including placement, soldering, applying adhesive, or other steps where the modules that make up the camera system are handled may cause movement of a light source relative to a camera module.

Described herein are camera systems, as well as electronic devices that includes these camera systems, that integrate a light source and a camera module into a common assembly. Accordingly, an electronic device that includes such a camera system may be able to illuminate a scene without requiring a separate light source module. Integrating one or more light sources into a camera system, such as described in more detail herein, may provide flash capabilities to the camera system without significantly increasing its footprint.

The described camera systems include a camera module mounted to a printed circuit board (a first printed circuit board). A light source may be positioned in proximity to the camera module using a bracket or a second printed circuit board. The light source may be coplanar with (e.g., in a same plane as) the camera aperture, and a light cone of the light source adjusted relative to the light cone of the camera module, for example to reduce or minimize reflections of light from the light source off of a transparent window into the camera module (e.g., through the aperture of the camera module).

In some examples, the light source is mounted to a top surface of that bracket that is positioned relative to the camera module (e.g., a housing of the camera module). In some examples, multiple light sources may be mounted to a top surface of the bracket. In some examples, the bracket may at least partially surround a lens barrel of the camera module. In some examples, the bracket may be mounted to the camera module and positioned such that an optical axis of the light source is aligned with an optical axis of the camera module.

In other examples, a second printed circuit board has a first portion and a second portion. The first portion may be disposed on a top surface of the camera module, and one or more light sources mounted to a top surface of the first portion of the second printed circuitry board. In some examples, the second printed circuit board may include some flexible portions (e.g., the second portion, or both the first and second portions) that provide an electrical connection to the first printed circuit board.

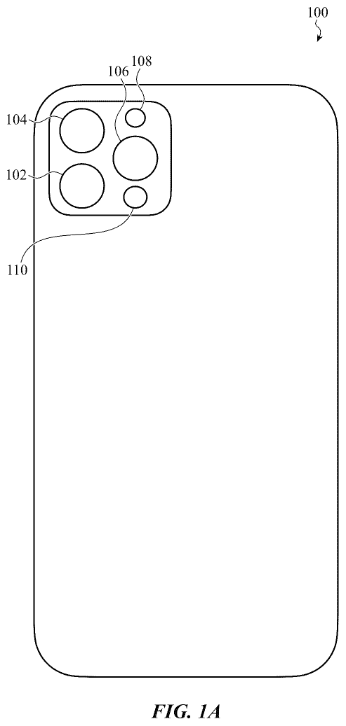

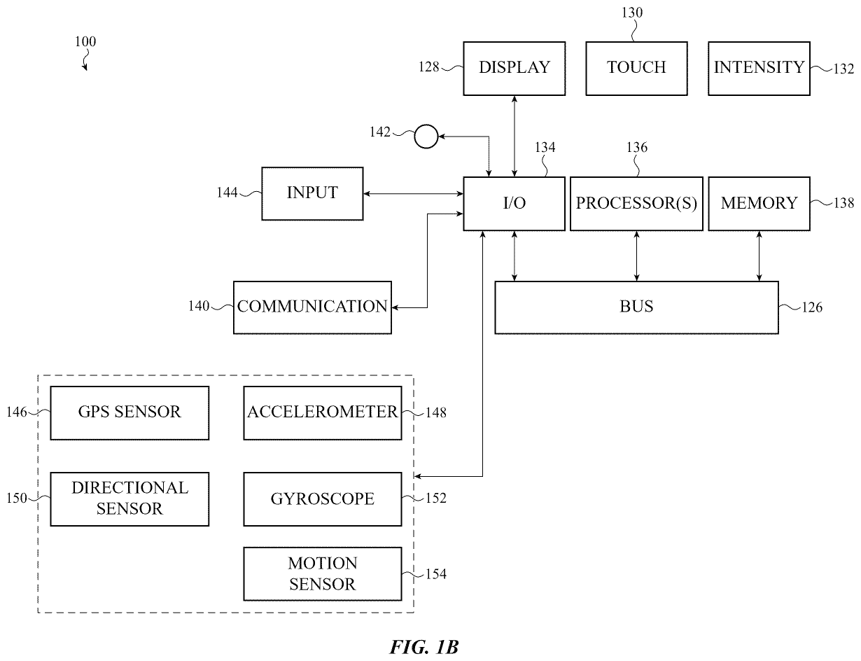

These and other embodiments are discussed below with reference to FIGS. 1A-7. However, those skilled in the art will readily appreciate that the detailed description given herein with respect to these figures is for explanatory purposes only and should not be construed as limiting.

The camera systems described herein may be incorporated into an electronic device such as a phone, tablet, computer, wearable device (e.g., a head-mounted device or a smartwatch), or the like. FIG. 1A shows a rear view of an illustrative example of a device including a camera system including a camera module and an integrated light source as described here.

FIG. 1A depicts an example device 100 as described herein. The device includes a first camera 102 that is a camera system having a camera module and an integrated light source, as further described herein.

In some instances, the first camera 102 is part of a multi-camera system. For example, in the variation shown in FIG. 1A, the first camera 102 is part of a multi-camera system having a second camera 104, and a third camera 106. In some variations, the second camera 104 and/or third camera 106 may also be camera systems, as described herein, including both a camera module and an integrated light source. It should be appreciated that the device 100 may include a single camera, or a multi-camera system having any number of cameras (with any relative positioning) as may be desired. Additionally, while shown as placed on the rear of a device 100, it should be appreciated that a camera having a camera system with a camera module and an integrated light source may be additionally or alternatively placed on the front (e.g., a front side having a display) or any other side of the device as desired.

In some instances, the device 100 may also include a light source module 108. The light source module 108 may be a separate light source module from the integrated light source modules of the first camera 102, the second camera 104, and/or the third camera 106. In some examples, the light source module 108 provides additional illumination, for example having different characteristics, than the integrated light source module of the first camera 102, the second camera 104, and/or the third camera 106. For example, one or more of the first camera 102, the second camera 104, and/or the third camera 106 may not include an integrated light source. The light source module 108 may provide illumination to the cameras that do not include the integrated light source.

Additionally, or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. In other embodiments, the device 100 is a wearable device. For example, in some instances the device 100 may be a head-mounted device, such as an extended reality (XR) device, which may include augmented reality (AR) or virtual reality (VR) devices. Exemplary embodiments of head-mounted devices include, without limitation, the Vision Pro® device from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples an I/O section 134 with one or more computer processors 136 and memory 138. The I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage media, for storing computer-executable instructions, which, when executed by one or more computer processors 136, for example, can cause the computer processors to perform the techniques that are described here (such as actuating the mechanical iris assemblies described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images as described herein. Device 100 is not limited to the components and configuration of FIG. 1B, but can include other or additional components in multiple configurations.

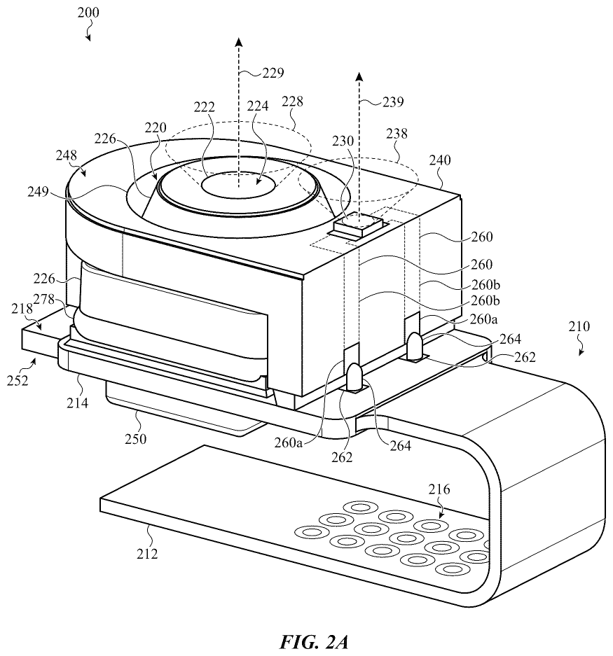

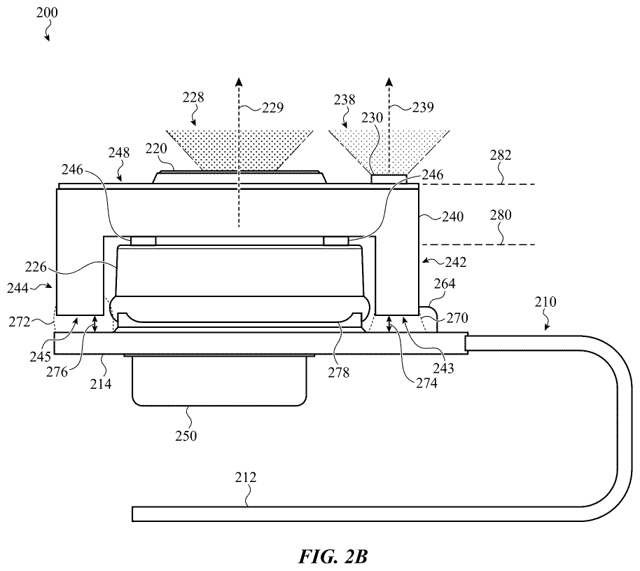

FIG. 2A shows a perspective view of a first example of a camera system 200 including a camera module and a light source, as described here. FIG. 2B depicts a side view of the first example of the camera system 200 of FIG. 2A.

The camera system 200 includes a printed circuit board 210, a camera module 220, one or more light sources including at least a first light source 230, and a bracket 240.

The printed circuit board 210 has a rigid portion 214 and a flexible portion 212. The printed circuit board 210 may provide both mechanical support for components of the camera system 200 and electrical interconnections with components of the camera system 200. For example, the printed circuit board 210 may facilitate the routing of signals (e.g., power signals, control signals, data signals, or the like) to and/or from the camera module 220 and the first light source 230. This may allow the components of the camera system 200 to be electrically connected to other components (e.g., one or more processors, power management units) of an electronic device that incorporates the camera system 200. In one or more examples, the printed circuit board 210 includes one or more interconnect layers for conductors, such as for the routing of conductive traces (e.g., copper), lines, planes, or other features. The printed circuit board may further include insulating layers, for example to provide mechanical support to the conductive traces and/or protect the conductors from inadvertent contact with other conductors.

One or more of the insulating layers may further provide rigidity to the printed circuit board 210, for example in the rigid portion 214, to provide a mechanically stiff support structure to which to mount the camera module 220. The rigid portion 214 may also be mechanically mounted or otherwise assembled into another portion of a larger device or housing (e.g., device 100). In some examples, the insulating portions or layers of the rigid portion 214 may be formed from or include composite materials such as fiberglass or FR4, plastics such as polyimide, or other suitable materials.

The flexible portion 212 may be integrated with the rigid portion 214 of the printed circuit board 210. The flexible portion 212 may provide interconnect in one or more flexible conductor layers (e.g., thin traces of copper or another conductor) and one or more flexible insulating layers. The flexible portion 212 may further provide a set of contacts 216 (e.g., pads and/or vias) to provide for connection to the interconnect signal paths between other components of a device (e.g., device 100) that include the camera system 200 and both of the camera module 220 and first light source 230 (e.g., via the set of electrical interconnects). In some examples, the insulating portions or layers of the flexible portion 212 may be or include a plastic such as polyimide, or another suitable material (e.g., a same or similar material as other flex ribbons or cables used in a device 100).

The camera module 220 may be mounted to the rigid portion 214 of the printed circuit board 210. In some examples, the rigid portion 214 of the printed circuit board 210 may have a set of pads or contact to which the camera module 220 may be mounted using solder bonds, adhesive, or a combination of these, to provide a stable connection between the printed circuit board 210 and the camera module 220. Additionally, or alternatively, adhesive 278 may be applied around and/or between the general area where the printed circuit board 210 and the camera module 220 are in contact or close proximity.

The camera module 220 includes a housing 226 that generally encloses other components of the camera module and provides external surfaces to contact and support other parts of the camera system 200. Examples of other components of the camera module 220 may include an image sensor (not shown), one or more lenses (not shown), one or more filters (e.g., an infrared filter) (not shown), and an actuator (not shown) to provide movement of the one or more lenses relative to the image sensor. The lens barrel 224 extends away from the optical sensor around the optical axis 229 of the camera module 220. An opening of the camera module 220 at an end of the lens barrel 224 forms an aperture 222 of the camera module 220 that provides an opening to allow the entrance of light into the lens barrel 224 and the image sensor. Note that only a portion of the lens barrel 224 is shown within the camera module 220.

The camera module 220 has a FOV 228. The FOV 228 is defined at least partly by the relative mechanical positioning of various parts of the camera module 220, including the size and position of the aperture 222 relative to the image sensor (not shown).

The camera module 220 may be mounted on a first side 218 of the printed circuit board 210. In some cases, a set of components 250 may be mounted on a second side 252 of the printed circuit board 210. Such components may include passive or active elements that support the functioning of the camera module 220, the first light source 230, or both.

The bracket 240 is mounted to the rigid portion 214 of the printed circuit board 210. The bracket 240 has a top surface 248 that generally faces away from the camera module 220 and the rigid portion 214 of the printed circuit board 210. The top surface 248 and the light-receiving end of the lens barrel 224 may face in a common direction. In the example of the camera system 200 of FIGS. 2A and 2B, the bracket 240 is configured to fully surround the lens barrel 224. That is, at least a portion of the camera module 220 extends through an aperture 249 defining an opening in the bracket 240, such that the aperture 222 of the camera module 220 is above the top surface 248 and the aperture 249.

The first light source 230 is mounted to the top surface 248 of the bracket 240. The first light source 230 is positioned and configured to provide a field of illumination (FOI) 238 and with an optical axis 239. In some examples, the first light source 230 is mounted to the bracket 240 such that it is positioned over at least a portion of the housing 226 of the camera module 220. In some examples, the first light source 230 may be an LED, or an array of LEDs.

The first light source 230 is electrically connected to a set of electrical interconnects between the rigid portion 214 of the printed circuit board 210 and the bracket 240, such that the first light source 230 is electrically connected to the printed circuit board 210 via the set of electrical interconnects. Each electrical interconnects include a traces 260 carried by the bracket 240 and electrically connected to the first light source 230, a pads 262 positioned on the rigid portion 214 of the printed circuit board 210, and a solder joint 264 electrically connecting the trace 260 to the pad 262. In some variations, such as shown in FIG. 2A, each trace 260 may be partially embedded within the bracket 240 to define at least one exposed portion 260a (e.g., to facilitate the electrical connection between the trace 260 and the pad 262) and at least one embedded portion 260b (e.g., to reduce the likelihood of inadvertent electrical contact with the trace 260). In other examples, other types of electrical interconnects may be used. For example, a set of wires may connect the first light source 230 to pads, vias, or other electrical contact points on the rigid portion 214.

In some variations, the bracket 240 has a set of standoffs 246 positioned to contact a top surface of the housing 226 of the camera module 220. Two standoffs are shown and visible for the set of standoffs 246 in camera system 200. Three, four, or more standoffs may be used for camera system 200. The set of standoffs 246 are configured to set a relative position between the bracket 240 and the camera module 220 in at least one direction (e.g., along the optical axis 229 of the camera module 220). The standoffs may be formed as part of the bracket 240 (e.g., as a monolithic piece) or may be formed separately from the bracket 240 and connected thereto, and generally protrude from a surface of the bracket 240 opposite the top surface 248. The standoffs of the set of standoffs 246 may be generally cylindrical, rectangular, cross-shaped, or any suitable shape to provide the relative position between the bracket 240 and the camera module 220. In some examples, the standoffs of the set of standoffs 246 may be configured and positioned such that a datum 280 of the camera module 220 is parallel to a datum 282 of the bracket 240 (e.g., the top surface 248 of the bracket 240). Stated differently, the set of standoffs 246 may be configured and positioned such that the top surface 248 of the bracket 240 (and with a face of the first light source 230) is parallel to the camera module 220 (e.g., with the aperture 222 and a face of the image sensor (not shown) of the camera module 220). It should be appreciated that in other variations, a top surface of the housing 226 may instead include the standoffs (e.g., formed as part of the housing 226), which may contact the bracket 240 to set a relative position between the bracket 240 and the camera module 220 in at least one direction.

The bracket 240 has at least a first leg 242 and a second leg 244. The first leg 242 has a first mounting surface 243 opposite the top surface 248 of the bracket 240, the first mounting surface 243 positioned in proximity to the rigid portion 214 of the printed circuit board 210, for example within a distance 274. The second leg 244 has a second mounting surface 245 opposite the top surface 248 of the bracket 240, the second mounting surface 245 positioned in proximity to the rigid portion 214 of the printed circuit board 210, for example within a distance 276. The second leg 244 is on an opposite side of the camera module 220 from the first leg 242 of the bracket 240. In other examples, the bracket 240 may have additional legs, for example a third or fourth leg.

When the bracket 240 is placed into contact with the housing 226 via the standoffs, the first leg 242 and the second leg 244 may be spaced apart from the rigid portion 214 of the printed circuit board 210 as shown in FIG. 2B. Adhesive 270 may be applied within the volume between the first mounting surface 243 and the rigid portion 214. Adhesive 272 may be applied within the volume between the second mounting surface 245 and the rigid portion 214. Adhesive 270 and adhesive 272 may provide stability for the bracket 240, maintain the set of standoffs 246 in contact with the housing 226, and otherwise maintain a position of the first light source 230 relative to the camera module 220 (e.g., to maintain alignment of the optical axis 229 with the optical axis 239).

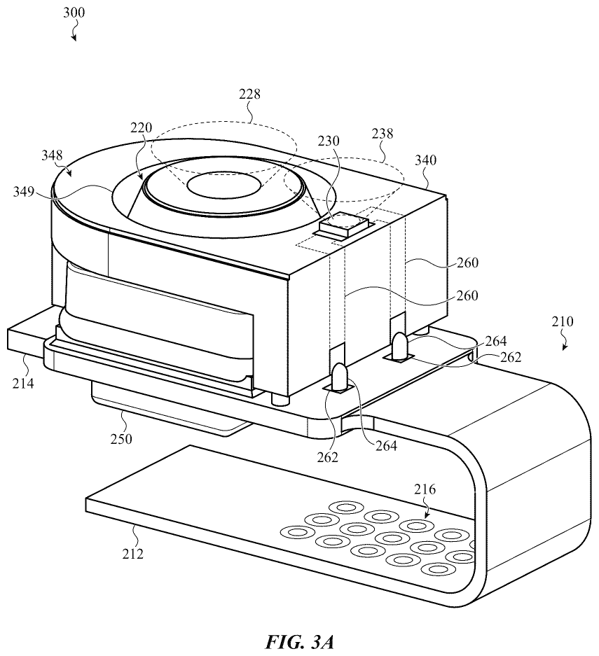

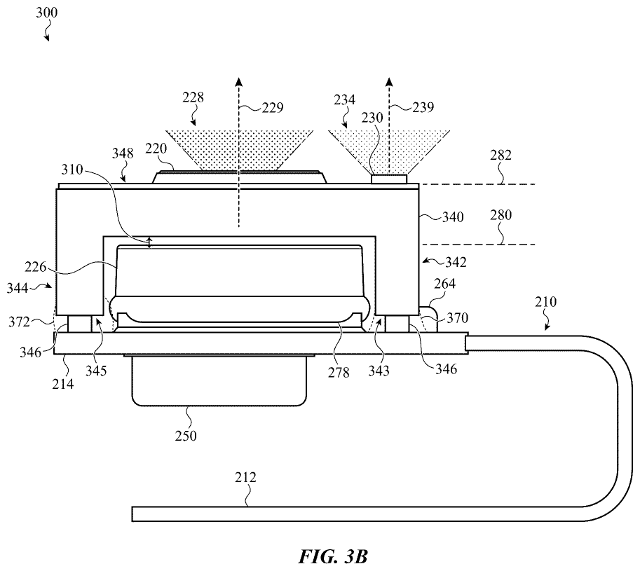

FIG. 3A shows a perspective view of a second example of a camera system 300 including a camera module and a light source, as described here. FIG. 3B depicts a side view of the second example of the camera system 300 of FIG. 3A. Elements having the same reference number refer to the same element in FIGS. 2A and 2B. The camera system 300 generally differs from the camera system 200 in the position of the set of standoffs.

The camera system 300 includes a printed circuit board 210, a camera module 220, a first light source 230, and a bracket 340. The bracket 340 has at least a first leg 342 and a second leg 344. The first leg 342 has a first bottom surface 343 opposite the top surface 348 of the bracket 340. The second leg 344 has a second bottom surface 345 opposite the top surface 348 of the bracket 340, the second bottom surface 345 positioned in proximity to the rigid portion 214 of the printed circuit board 210, for example within a distance 276. The second leg 344 is on an opposite side of the camera module 220 from the first leg 342 of the bracket 340.

Bracket 340 generally differs from bracket 240 of the camera system 200 in that the bracket 340 is configured to contact the rigid portion 214 in order to set the relative alignment between the bracket 340 and the camera module 220 along the optical axis 229 of the camera module 220. For example, the bracket 340 may include a set of standoffs 346 are positioned to contact the rigid portion 214 of the printed circuit board 210. The set of standoffs 246 are configured to provide a relative position between the bracket 340 and the camera module 220. The set of standoffs 346 may be formed as part of the bracket 340 (e.g., as a monolithic piece) or may be formed separately from the bracket 340 and connected thereto. A first standoff of the set of standoffs 346 generally protrudes from a first bottom surface 343 opposite the top surface 348 of the bracket 340. A second standoff of the set of standoffs 346 generally protrudes from a second bottom surface 345 opposite the top surface 348 of the bracket 340. The standoffs of the set of standoffs 346 may be generally cylindrical, rectangular, cross-shaped, or any suitable shape to provide the relative position between the bracket 340 and the camera module 220. In some examples, the standoffs of the set of standoffs 346 may be configured and positioned such that a datum 280 of the camera module 220 is parallel to a datum 282 of the bracket 240 (e.g., the top surface 348 of the bracket 340). Stated differently, the set of standoffs 346 may be configured and positioned such that the top surface 348 of the bracket 340 (and with a face of the first light source 230) is parallel to the camera module 220 (e.g., with the aperture 222 and a face of the image sensor (not shown) of the camera module 220). In some instances, the bracket 340 may not directly contact the housing 226 of the camera module 220, such that a gap 310 may exist between the bracket 340 and the camera module 220.

Two legs are shown and visible for the bracket 340 of the camera system 300. In other examples, the bracket 340 may have additional legs, for example a third or fourth leg. Also, two standoffs are shown and visible for the set of standoffs 346 in camera system 300. Three, four, or more standoffs may be used for camera system 300. In an example of three standoffs, the first leg 342 may be configured to have a first standoff of the set of standoffs 346, while the second leg 344 may be configured to have a second standoff and a third standoff of the set of standoffs 346. In an example of four standoffs, the first leg 342 may be configured to have a first standoff and a second standoff of the set of standoffs 346, while the second leg 344 may be configured to have a third standoff and a fourth standoff of the set of standoffs 346.

Adhesive 370 may be applied within the volume between the first bottom surface 343 and the rigid portion 214 (e.g., at least partially surrounding the first standoff of the set of standoffs 346). Adhesive 372 may be applied within the volume between the second bottom surface 345 and the rigid portion 214 (e.g., at least partially surrounding the second standoff of the set of standoffs 346). Adhesive 370 and adhesive 372 may provide stability for the bracket 340, hold the set of standoffs 346 to contact the rigid portion 214, and otherwise maintain a position of the first light source 230 relative to the camera module 220 (e.g., to maintain alignment of the optical axis 229 with the optical axis 239).

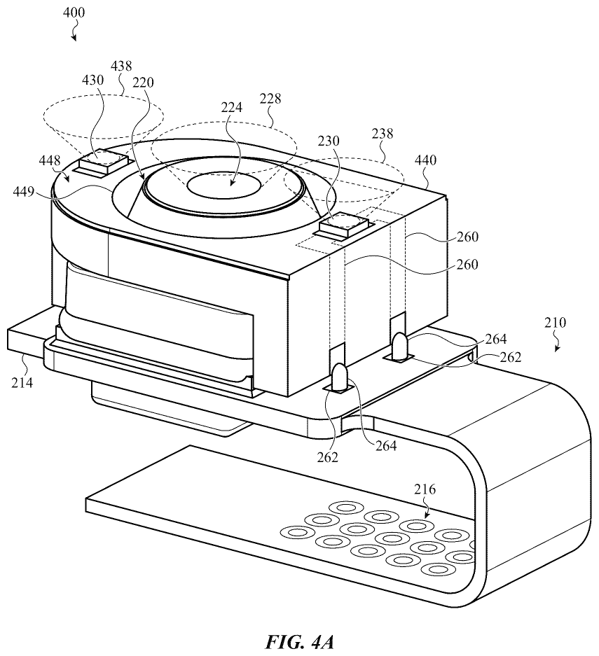

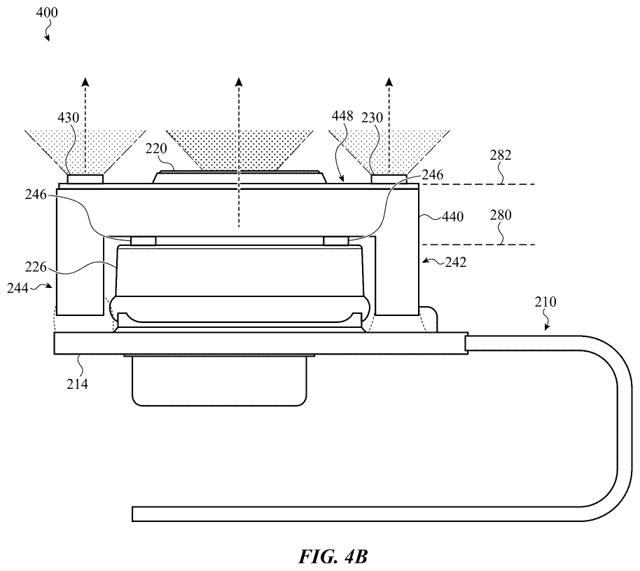

FIG. 4A shows a perspective view of an example of a camera system including a camera module and two light sources, as described here. FIG. 4B depicts a side view of the example of the camera system of FIG. 4A. Elements having the same reference number refer to the same element in FIGS. 2A-3B. The camera system 400 generally differs from the camera system 200 and the camera system 300 in having an additional light source module mounted to the top surface of the bracket.

In particular, the second light source 430 is mounted to the top surface 448 of the bracket 440. In some examples, the second light source 430 may be mounted on an opposite side of the lens barrel 224 from the first light source 230. A first set of electrical interconnects may connect the first light source 230 to the printed circuit board 210 (e.g., using traces 260 to pads 262 on the rigid portion 214). In some of these variations, the first set of electrical interconnects may connect both the first light source 230 and the second light source 430 to the printed circuit board 210. For example, the first light source 230 and the second light source 430 may be connected in parallel, such that the same set of signals (e.g., a common power signal) may be used to operate both the first light source 230 and the second light source 430. In other variations, the bracket 440 may include a second set of electrical interconnects that electrically connects the second light source 430 to the printed circuit board 210. In some examples, the first set of electrical interconnects and second set of electrical interconnects may be formed on a connector the bracket 440 to the printed circuit board 210 via a common side of the bracket 440 (e.g., via the first leg 242). In other examples, the second set of electrical interconnects from each terminal of the second light source 430 may be routed to the printed circuit board 210 from the top surface 448 via the second leg 244, for example such that the first light source 230 and the second light source 430 are separately controllable through a different set of electrical connections. In yet other examples, wires may be run from the second light source 430 to the printed circuit board 210.

The camera system 400 includes a set of standoffs 246 positioned to contact the housing 226 the camera module 220. Two standoffs are shown and visible for the set of standoffs 246 in camera system 400, but three, four, or more standoffs may be used for camera system 400. In other examples, a set of standoffs (not shown) may be positioned between the first leg 242 and the rigid portion 214 of the printed circuit board 210 and between the second leg 244 and the rigid portion 214 of the printed circuit board 210, with features as described with reference to camera system 300.

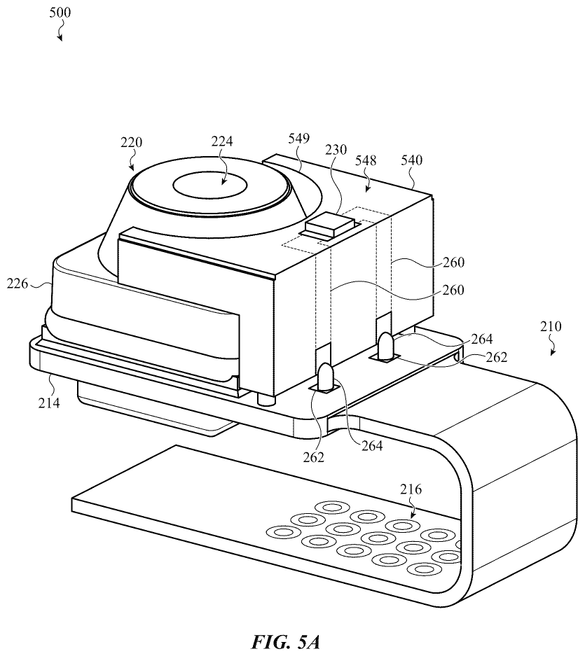

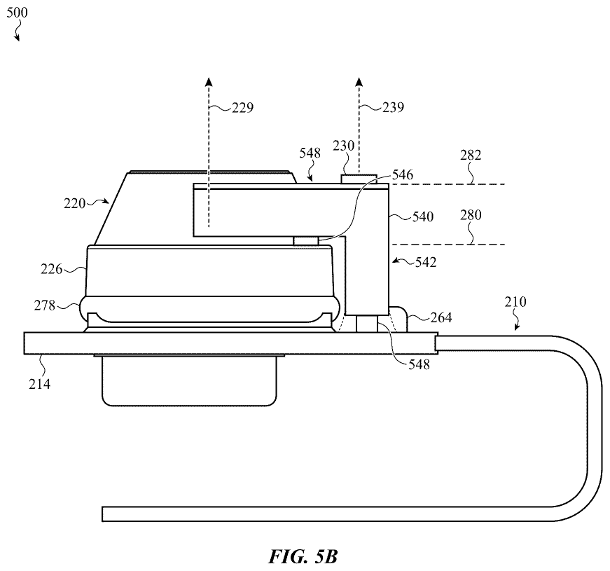

FIG. 5A shows a perspective view of a third example of a camera system including a camera module and a light source, as described here. Elements having the same reference number refer to the same element in FIGS. 2A-4B. The camera system 500 generally differs from the camera system 200, camera system 300, and camera system 400 in that the bracket partially, but does not fully, surround the lens barrel of the camera module and may use a different configuration of standoffs.

The bracket 540 at least partially surrounds the lens barrel 224. The bracket 540 includes a set of standoffs that support the bracket 540 and are configured to provide a relative position between the bracket 540 and the camera module 220. The set of standoffs includes a first standoff 546 to positioned to contact a housing 226 of the camera module 220. Although not shown, the set of standoffs may include one or more additional standoffs configured and positioned to contact the housing 226 of the camera module 220. The set of standoffs further includes a second standoff 548 positioned to contact the rigid portion 214 of the printed circuit board 210. The second standoff 548 may extend away from a bottom surface of a leg 542 of the bracket 540 to contact the rigid portion 214. Although not shown, the set of standoffs may include one or more additional standoffs configured and positioned to contact the housing 226 of the camera module 220 that extend away from the bottom surface of the leg 542 to contact the rigid portion 214.

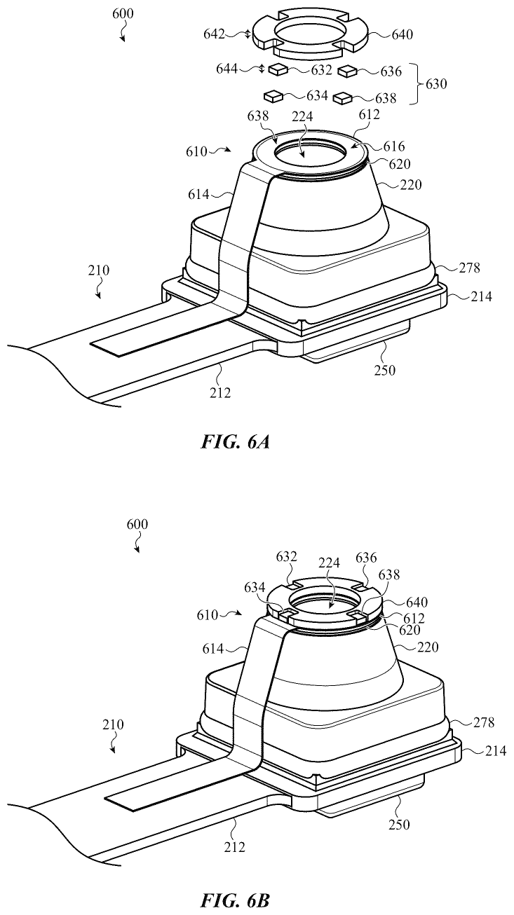

FIG. 6A shows an exploded perspective view of an example of a camera system 600 including a camera module and a set of light sources, as described here. FIG. 6B depicts a perspective view of the example of the camera system 600 of FIG. 6A. Elements having the same reference number refer to the same element in FIGS. 2A-5B. The camera system 500 generally differs from the camera system 200, camera system 300, camera system 400, and camera system 500 in that the light source is mounted to a top surface of a second printed circuit board.

The camera system 600 includes a first printed circuit board (the printed circuit board 210), a second printed circuit board 610, a camera module 220, a set of light sources 630, a set of electrical interconnects of the second printed circuit board 610, a light blocking ring 640, and a stiffener 620.

The printed circuit board 210 has a flexible portion 212 and a rigid portion 214. The camera module 220 may have a lens barrel 224 and be mounted to the rigid portion of the printed circuit board 210, as further described herein.

The second printed circuit board 610 has a first portion 612 and a second portion 614. The first portion 612 disposed on a top surface of the camera module 220, and the second portion 614 that is mounted to the printed circuit board 210. The first portion 612 at least partially surrounds the lens barrel 224. In some examples, the second portion 614 may be mounted to the printed circuit board 210 at the flexible portion 212. In other examples, the second portion 614 may be mounted to the printed circuit board 210 at the rigid portion 214.

In some examples, a stiffener 620 may be disposed on the top surface of the camera module 220. The first portion 612 of the second printed circuit board 610 may then be disposed on a top surface of the stiffener 620. The stiffener 620 at least partially surround the lens barrel 224. In some examples, the stiffener 620 may be under a at least a part of the first portion 612 of the second printed circuit board 610. In some examples, the stiffener 620 may be configured and positioned on the camera module 220 to provide further mechanical support to the first portion 612 of the second printed circuit board 610, in particular to stiffen the first portion 612 for mounting of the light sources 630. For example, in some cases, the camera module 220, by itself in the absence of the stiffener 620 may provide an inadequately stable platform for the first portion 612 for mounting of the light sources 630. That is, the light sources 630 may experience improved stability with the use of the stiffener 620, and prevent or help prevent undesirable movement during manufacture or use.

The set of light sources 630 includes at least a first light source 632. The first light source 632 is mounted to a top surface of the first portion 612 of the second printed circuit board 610. In some examples, the set of light sources 630 includes at least a first light source 632 and another light source (e.g., third light source 636) mounted on an opposite side of the lens barrel 224 from the first light source 632. In some examples (as shown), the set of light sources 630 also include a second light source 634, a third light source 636, and a fourth light source 638. Although shown as even spaced around the lens barrel 224, the set of light sources 630 may have other arrangements, patterns, or configurations consistent with the description herein.

The camera system 600 includes a set of electrical interconnects (not shown) between the printed circuit board 210 and the first portion 612 of the second printed circuit board 610. In some examples the set of electrical interconnects may be traces of conductors on or within the second printed circuit board 610, including on or within the first portion 612. The first light source 632 is electrically connected to the printed circuit board 210 (the first printed circuit board) via the set of electrical interconnects. In the examples where the set of light sources 630 include two or more light sources (e.g., the second light source 634, the third light source 636, and the fourth light source 638) all the light sources may be connected in parallel and jointly controllable. In other examples, one or more of the light sources of the set of light sources 630 may have their own electrical connections such that the different light sources of the set of light sources 630 may be separately controllable.

The light blocking ring 640 of the camera system 600 is disposed on the first portion 612 of the second printed circuit board 610. The light blocking ring 640 may at least block light emitted by the light sources of the first set of light sources 630 from entering the camera module 220 (e.g., the lens barrel 224 of the camera module 220). The light blocking ring 640 is configured to contact a transparent window, for example when the camera system 600 is positioned and installed within a device (e.g., a device 100) that includes a transparent window. The light blocking ring 640 may have a first height 642 from the top surface 616 of the second printed circuit board 610 that is greater than a second height 644 of the first light source 632 from the top surface 616 of the second printed circuit board 610. In some examples, the light blocking ring 640 may be at partially compressible when pressed into or otherwise in contact with the transparent window, such that the first height 642 of the light blocking ring 640 may be selected and configured to ensure that the light sources of the set of light sources 630 avoid contacting the transparent window.

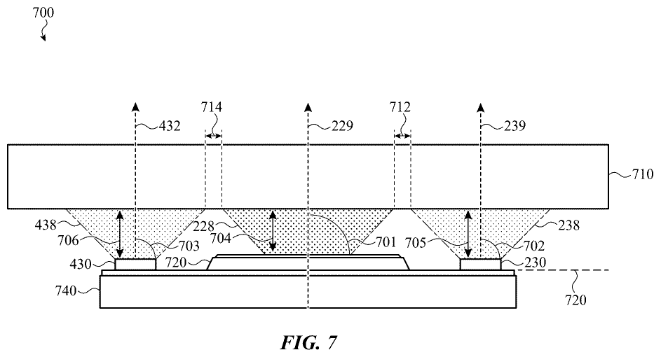

FIG. 7 shows a side view of an example of a portion 700 of a camera system including a camera module and two light sources, as described here. Elements having the same reference number refer to the same element in FIGS. 2A-6B, including FIGS. 4A-4B in particular. The camera system of which the portion 700 is a portion, may be the camera system 400.

The portion 700 includes a top part 720 of a camera module 220, top part 740 of a bracket 440, a first light source 230, a second light source 430, and a transparent window 710. The transparent window 710 may have a position that is fixed and maintained by the installation of the camera system 400 (including the portion 700) in a device, such as device 100, that supports the transparent window 710. Although not shown, other mechanism or features of the device may control a distance that separates components of the portion 700 from the transparent window 710. A top surface of the camera module 220 may have a distance 704 from the transparent window 710. The first light source 230 may have a distance 705 from the transparent window 710. The second light source 430 may have a distance 706 from the transparent window 710.

The camera module 220 has a FOV 228 defined by a FOV angle 701 relative to the optical axis 229 that represents the angular extent to which the camera module 220 may collect and measure light. The first light source 230 emits light with a first FOI 238 having a first FOI angle 702 relative to the optical axis 239 that represents the angular extent to which the first light source 230 may emit light. In some examples, the first FOI 238 is at least as wide as the FOV 228 (e.g., the first FOI angle 702 is at least as large as the FOV angle 701). In some examples, the first FOI 238 is the same as the FOV 228 (e.g., the FOV angle 701 is the same as the first FOI angle 702). The second light source emits light with a second FOI 438 having a second FOI angle 703 relative to the optical axis 432. In some examples, the second FOI 438 is at least as wide as the FOV 228 (e.g., the second FOI angle 703 is at least as large as the FOV angle 701). In some examples, the second FOI 438 is the same as the FOV 228. In some examples the first FOI 238 is the same as the second FOI 438 (e.g., the FOV angle 701 is the same as the second FOI angle 703).

The position of the first light source 230 relative to camera module 220 (and the top portion of the camera module 220) may be selected so that the distance 712 between where the first FOI 238 intersects with the transparent window 710 and where the FOV 228 intersects with the transparent window is sufficient so that reflections of light emitted by the first light source 230 do not enter the camera module 220. For example, if the FOV angle 701 and the first FOI angle 702 have a same value (e.g., the same angle, which may be desirable for so that the FOV 228 and the first FOI 238 substantially overlap at a scene), the distance 712 may be zero or greater. That is, distance 712 may be selected so that the first FOI 238 and the FOV 228 do not overlap where they intersect the transparent window.

In some examples, the distance 714 may be selected to be the same as distance 712. In other examples, the distance 714 may also be zero or greater, but the distance 714 may be different than distance 712. For example, the distance 714 may be somewhat greater or less than distance 712 for somewhat different mechanical placements of the second light source 430, for example to avoid or otherwise accommodate various parts or components, such as a light blocking ring (e.g., the light blocking ring 640 of camera system 600) or electrical component (e.g., traces, pads, or wires).

In some examples, each of the distance 712 and the distance 714 may be selected so that the first light source 230 and the second light source 430, respectively, are able to be mounted on a top surface of the top part 740.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

1. A camera system comprising:
a printed circuit board having a flexible portion and a rigid portion;
a camera module mounted to the rigid portion of the printed circuit board and comprising a lens barrel;
a bracket;
a first light source mounted to a top surface of the bracket; and
a set of electrical interconnects between the rigid portion of the printed circuit board and the bracket, wherein:
the bracket at least partially surrounds the lens barrel;
the bracket is mounted to at least the rigid portion of the printed circuit board; and
the first light source is electrically connected to the printed circuit board via the set of electrical interconnects.

2. The camera system of claim 1, wherein:
the bracket fully surrounds the lens barrel.

3. The camera system of claim 1, wherein the bracket further comprises:
a set of standoffs positioned to contact the camera module, the set of standoffs configured to provide a relative position between the bracket and the camera module.

4. The camera system of claim 3, wherein:
the set of standoffs extend from a bottom surface of the bracket and contact a top surface of a housing of the camera module.

5. The camera system of claim 1, wherein:
an angular field of illumination of the first light source is at least as wide as an angular field of view of the camera module.

6. The camera system of claim 5, wherein:
the angular field of illumination of the first light source is a same width as the angular field of view of the camera module.

7. The camera system of claim 1, further comprising:
a second light source mounted to the top surface of the bracket.

8. The camera system of claim 7, wherein:
the second light source is mounted on an opposite side of the lens barrel from the first light source.

9. The camera system of claim 1, wherein:
the set of electrical interconnects comprise electrical traces carried by the bracket.

10. The camera system of claim 1, wherein the bracket comprises:
a first leg having a first mounting surface opposite the top surface of the bracket, the first mounting surface positioned to contact the rigid portion of the printed circuit board to provide a relative position between the bracket and the camera module.

11. The camera system of claim 10, wherein:
the first leg supports the set of electrical interconnects.

12. The camera system of claim 10, further comprising:
a second leg having a second mounting surface opposite the top surface of the bracket, the first mounting surface and the second mounting surface positioned to contact the rigid portion of the printed circuit board to provide the relative position between the bracket and the camera module, the second leg on an opposite side of the camera module from the first leg of the bracket.

13. A camera system, comprising:
a printed circuit board;
a camera module mounted to the printed circuit board and comprising a lens barrel;
a bracket;
a first light source mounted to a top surface of the bracket; and
a set of electrical interconnects between the printed circuit board and the bracket, wherein:
the first light source is positioned over a portion of a housing of the camera module;
the bracket is mounted to the camera module to align an optical axis of the first light source with an optical axis of the camera module; and
the first light source is electrically connected to the printed circuit board via the set of electrical interconnects.

14. The camera system of claim 13, wherein the bracket further comprises:
a set of standoffs positioned to contact the camera module, the set of standoffs configured to provide a relative position between the bracket and the camera module.

15. The camera system of claim 14, wherein:
the set of standoffs extend from a bottom surface of the bracket and contact a top surface of the housing of the camera module.

16. The camera system of claim 13, wherein:
the first light source is positioned coplanar with an input aperture of the camera module.

17. A camera system, comprising:
a first printed circuit board having a flexible portion and a rigid portion;
a camera module mounted to the rigid portion of the first printed circuit board and comprising a lens barrel;
a second printed circuit board having a first portion and a second portion, the first portion disposed on a top surface of the camera module, and the second portion mounted to the first printed circuit board;
a first light source mounted to a top surface of the first portion of the second printed circuit board; and
a set of electrical interconnects between the first printed circuit board and the first portion of the second printed circuit board, wherein:
the first portion of the second printed circuit board at least partially surrounds the lens barrel; and
the first light source is electrically connected to the first printed circuit board via the set of electrical interconnects.

18. The camera system of claim 17, further comprising:
a light blocking ring disposed on the first portion of the second printed circuit board and configured to contact a transparent window, wherein:
a first height of the light blocking ring from the top surface of the second printed circuit board is greater than a second height of the first light source from the top surface of the second printed circuit board.

19. The camera system of claim 17, further comprising:
a second light source mounted to the top surface of the first portion of the second printed circuit board, wherein:
the second light source is mounted on an opposite side of the lens barrel from the first light source.

20. The camera system of claim 17, further comprising:
a stiffener that is disposed on the top surface of the camera module and that at least partially surrounds the lens barrel, wherein:
the first portion of the second printed circuit board is disposed on a top surface of the stiffener.
